(19) United States
(12) Patent Application Publication
(10) Pub. No.: US 2006/0182890 A1
(43) Pub. Date: Aug. 17, 2006

(54) Blade coating method and apparatus

(75) Inventors: Shinsuke Takahashi, Kanagawa (JP); Takayoshi Ose, Kanagawa (JP); Satoshi Matsubaguchi, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/337,644

(22) Filed: Jan. 24, 2006

(30) Foreign Application Priority Data
Feb. 14, 2005 (JP) P. 2005-035740

(51) Int. Cl. B05D 3/12; B05C 11/02

(52) U.S. Cl. 427/355; 118/126; 118/261; 118/413

(57) ABSTRACT

A blade coating method using a blade for coating a surface of a flat substrate with a coating liquid to form a coating layer on a to-be-coated surface of the flat substrate, the method comprising: the attaching step as defined herein; and the moving step as defined herein, wherein the quantity of the coating liquid remaining in the liquid reservoir on the upstream side of the blade is set to be in a range of from two times to five times as much as a quantity of the coating liquid to be applied on one sheet of the flat substrate with a stroke of the blade.

### FIELD OF THE INVENTION

The present invention relates to a blade coating method and apparatus for applying a coating liquid on a flat substrate.

### BACKGROUND OF THE INVENTION

A coating method such as roll coating, gravure coating and extrusion coating is heretofore known as a coating method for applying a coating liquid on a support.

A blade coating method as described in JP-A-5-220966 is also known as a coating method for applying a coating liquid on a flat substrate.

### SUMMARY OF THE INVENTION

FIG. 1 is a perspective view showing a blade coating apparatus as a subject of the invention. FIG. 2 is an enlarged sectional view of a blade.

The blade coating apparatus 10 is used for applying a coating liquid on a flat substrate to form a coating layer. A disk-like recording medium (hereinafter referred to as “disk”) D which is an example of the flat substrate is used as a subject of coating.

The disk D is supported by a support member 40 (FIGS. 3A to 3C) while a to-be-coated surface of the disk D to be coated with the coating liquid is turned up. The support member 40 is formed so that the support member 40 can be driven to move up and down. Accordingly, the vertical position of the flat substrate can be adjusted to a predetermined position at any time, for example, at the time of placing the disk D on the support member, at the time of removing the disk D from the support member after coating, or at the time of performing coating.

A plate-like mask 30 is provided above the disk D. The mask 30 has an aperture 30a for exposing a to-be-coated surface D1 as an upper surface of the disk D on which a coating layer will be formed. The aperture 30a is shaped like a circle with a diameter of about 120 mm. Incidentally, the shape of the aperture 30a can be formed in accordance with the shape of the coating layer which will be formed on the disk D. When the shape of the aperture of the mask 30 is changed suitably, the shape of the coating layer can be set desirably. At the time of coating the disk D, the supported disk D is attached onto a lower surface of the mask 30 and retained in the condition that an outer circumferential edge of the disk D overlaps with a circumferential edge of the aperture of the mask 30 in view from above.

A blade 20 is provided above the mask 30. The blade 20 is a long member made of a metal material such as a stainless steel material. Particularly, it is preferable that the chromium content of the blade 20 is selected to be not lower than the chromium content of SUS316. In this manner, wear resistance, corrosion resistance, heat resistance and releasability of the blade 20 can be improved more greatly. As shown in FIG. 2, the blade 20 is formed so that a section of the blade 20 perpendicular to the lengthwise direction of the blade 20 is substantially shaped like a trapezoid.

The blade coating apparatus 10 is provided with a coating liquid supply unit 60 for supplying a coating liquid to an upper surface of the mask 30. The coating liquid supply unit 60 supplies a predetermined amount of a coating liquid P onto the upper surface of the mask 30 and between the aperture 30a and the blade 20 before coating or at every coating.

As shown in FIG. 2, a gap G is formed between the blade 20 and the mask 30. As a flow of the coating liquid P is guided by a front surface 20a of the blade 20, the coating liquid P is pressed and forced into the gap G. A pressure surface 20b is formed as a lower end surface of the blade 20 facing the to-be-coated surface D1. When the coating liquid P passes through the pressure surface 20b by a distance L, the coating liquid P is loaded into the aperture 30a of the mask 30. As shown in FIG. 1, at the time of coating, the blade 20 moves along the mask surface above the mask 30 while the front surface 20a presses the coating liquid P against the aperture 30a side. In this manner, the coating liquid P is applied on the to-be-coated surface D1 evenly.

It is preferable that a coating liquid with a viscosity of 150 cP to 800 cP is used as the coating liquid P. It is especially preferable that a coating liquid with a viscosity of 200 cP to 700 cP is used as the coating liquid P.

It is preferable that an angle α between the pressure surface 20b and the front surface 20a of the blade 20 is set to be in a range of 110°≦α≦150°. In addition, it is preferable that an angle β between the pressure surface 20b and a rear surface 20c of the blade 20 is set to be in a range of 60°≦β≦100°. Moreover, it is preferable that the gap G between the pressure surface 20b of the blade 20 and the mask 30 is set to be in a range of 20 μm≦G≦150 μm.

Next, a method using the blade boating apparatus 10 for applying the coating liquid will be described.

FIGS. 3A to 3C are explanatory views showing the first half of a procedure in the coating method according to the invention. FIGS. 4D to 4G are explanatory views showing the second half of the procedure in the coating method according to the invention.

In this blade coating method, a coating liquid P is applied on a to-be-coated surface D1 of a disk D exposed from the aperture 30a of the mask 30 under the condition that at least one of straightness and center-line average surface roughness satisfies the aforementioned ranges to make the blade 20 satisfy the aforementioned ranges.

First, the disk D is disposed on the support member 40 shaped like a table. As shown in FIG. 3A, the support member 40 is moved up to make the disk D abut on the aperture 30a of the mask 30.

Then, as shown in FIG. 3B, a mask cap 50 is moved down toward a central hole D2 of the disk D. Finally, as shown in FIG. 3C, the mask cap 50 is inserted into the central hole D2 of the disk D. The coating liquid P is supplied onto an end of the mask 30 by the coating liquid supply unit 60 shown in FIG. 1. The blade 20 is moved in a direction represented by an arrow Y.

FIG. 4D shows a state in which the blade 20 is to reach the aperture 30a after the movement of the blade 20 starts. FIG. 4E shows a state in which the blade 20 has already passed through the aperture 30a.

By the movement of the blade 20 from right to left in FIGS. 4D and 4E, a coating liquid layer with a predetermined thickness t1 is formed on the to-be-coated surface D1 of the disk D because the blade 20 passes through the to-be-coated surface D1 of the disk D while carrying the coating liquid P.

Then, as shown in FIG. 4F, the mask cap 50 is pulled out of the disk D.

In this manner, a circular step portion D2 which is not coated with the coating liquid P is formed in a central portion of the disk D. Then, as shown in FIG. 4G, the support member 40 is moved down so that the disk D is pulled down apart from the aperture 30a of the mask 30. Thus, the coating liquid P applied on the to-be-coated surface D1 is separated from the coating liquid P remaining on the mask 30. As a result, an uncoated portion D3 which is not coated with the coating liquid P is formed in an outer circumferential edge of the disk D covered with the mask 30.

The disk D completely coated with the coating liquid P as described above is removed from the support member 40 and transferred to a coating liquid drying process as a next process not shown.

FIGS. 5A and 5B are views showing a state in which the disk D is separated from the mask. FIG. 5A is a perspective view showing the time of ascending of the support member. FIG. 5B is a perspective view showing the time of descending of the support member. In the blade coating apparatus 10, while the disk D is supported by the support member 40 which can be driven to move up and down, a drive member 41 drives the support member 40 to move up to an upper position so that a portion of the disk D except the to-be-coated portion is attached to a mask 30 having an aperture 30a. In this condition, a long blade 20 is moved in the direction of the arrow Y above the upper surface of the mask 30 to thereby scrape and extend the coating liquid P supplied onto the mask 30. In this manner, the coating liquid P is accumulated on the to-be-coated portion exposed from the aperture 30a, so that a coating layer of the coating liquid P is formed on the disk D.

After the coating liquid is applied on the disk D, the mask cap 50 (FIG. 4F) is removed. As shown in FIG. 5B, the support member 40 is then moved down so that the flat substrate D having the coating layer P formed thereon is separated from the mask 30.

For example, this coating method can be applied to a means of forming a printing surface on a disk-like substrate by blade coating (or doctor blade coating) in a process for producing a magnetic recording medium including the substrate. FIG. 6 is a plan view of a disk coated with a coating liquid by such a coating method using the blade 20 and the mask 30. In view of the disk, almost 100% of the whole surface of the disk D is coated with a coating liquid, that is, slight portions such as a central portion D2 of the disk D and an outer circumferential portion D3 of the disk D are not coated with a coating liquid.

Such a printing method is a high-aperture-ratio coating method which is unconceivable from any other method such as screen printing. Accordingly, a phenomenon unconceivable from the screen printing which is small in rate of coating liquid consumption used at one stroke appears in the blade coating using the high-aperture-ratio mask.

The present inventor inspected a coating layer formed on a surface of a disk by blade coating using such a high-aperture-ratio mask. As a result, it was found that stripes occurred in end portions of the coating layer on the surface of the disk D in one case, a swollen coating portion occurred at an upstream end of the disk D in another case, and thickness irregularity occurred on the whole surface of the disk D in a further case.

Therefore, causes of these disadvantages were pursued. As a result, it was ascertained that the quantity of a coating liquid supplied initially and the quantity of coating liquid consumption used at one stroke are correlated with each other, and that these disadvantages are caused by the correlation. In order to solve these problems, therefore, an object of the invention is to provide a blade coating method in which a coating layer with a very uniform thickness can be formed without occurrence of any stripe in end portions of the coating layer on a surface of a disk D, without occurrence of any swollen coating portion at an upstream end of the disk D and without occurrence of any thickness irregularity on the whole surface of the disk D.
(1) To solve the problem, the invention provides a blade coating method using a blade for coating a surface of a flat substrate with a coating liquid to form a coating layer on a to-be-coated surface of the flat substrate, including the steps of: attaching a mask onto the flat substrate, the mask having an aperture large enough to apply the coating liquid on the whole surface of the flat substrate except a circumferential edge portion of the flat substrate; and moving the blade from an upstream side to a downstream side relative to the mask with a predetermined gap formed between the blade and the flat substrate, thereby extruding the coating liquid onto the mask through the gap formed on the downstream side of the blade while moving a quantity of the coating liquid remaining in a liquid reservoir on the upstream side of the blade by the blade to thereby form the coating layer on the surface of the flat substrate; wherein the quantity of the coating liquid remaining in the liquid reservoir on the upstream side of the blade is set to be in a range of from two times to five times as much as a quantity of the coating liquid to be applied on one sheet of the flat substrate with a stroke of the blade.
(2) In the blade coating method according to the paragraph (1), the surface of the flat substrate is a printable surface of a printable optical disk.
(3) The invention also provides an optical disk having at least one layer of a printable surface formed by a blade coating method according to the paragraph (1) or (2).
(4) The invention further provides a blade coating apparatus including: a subject attachment for attaching a flat substrate as a subject on which a coating liquid is applied; a blade disposed above the subject attachment so that the blade moves from an upstream side toward a downstream side relative to the subject attachment with a predetermined gap formed between the subject attachment and the blade; a nozzle for discharging the coating liquid onto the upstream side of the blade; and a coating liquid quantity controller for controlling the quantity of the coating liquid to be discharged from the nozzle; wherein the coating liquid quantity controller controls the quantity of the coating liquid to be discharged from the nozzle so that the quantity of the coating liquid to be discharged from the nozzle is set to be in a range of from two times to five times as much as a quantity of the coating liquid to be applied on one sheet of the flat substrate with a stroke of the blade.

In the blade coating method according to the invention, a coating layer with a very uniform thickness can be formed without occurrence of any stripe in end portions of the coating layer on a surface of a disk D, without occurrence of any swollen coating portion at an upstream end of the disk D and without occurrence of any thickness irregularity on the whole surface of the disk D.

### BRIEF DESCRIPTION OF THE DRAWINGS

FIG. 1 is a perspective view showing a blade coating apparatus.

FIG. 2 is an enlarged sectional view of a blade.

FIGS. 3A to 3C are explanatory views showing a procedure in a coating method according to the invention.

FIGS. 4D to 4G are explanatory views showing the procedure in the coating method according to the invention, following FIG. 3C.

FIGS. 5A and 5B are views showing a state in which a subject of coating (disk) is separated from a mask.

FIG. 6 is a plan view of the subject (disk) after coating.

FIGS. 7A and 7B are view showing definitions of the whole quantity P1 of a coating liquid supplied and the quantity P2 of the whole coating layer applied in an experiment according to the invention.

### DESCRIPTION OF REFERENCE NUMERALS AND SIGNS

10 blade coating apparatus
20 blade
20a front surface of the blade
20b pressure surface of the blade
20c rear surface of the blade
30 mask
30a aperture
40 support member
50 mask cap
60 coating liquid supply unit
D disk-like recording medium (disk) as a subject of coating
D1 to-be-coated surface
D2 central hole of the disk
D3 uncoated portion
P coating liquid
Y direction of movement of the blade
Z direction of vertical movement of support member
t1 gap between the blade and the to-be-coated surface

### DETAILED DESCRIPTION OF THE INVENTION

An embodiment of the invention as to a blade coating apparatus and a disk printing surface coating apparatus using the blade coating apparatus will be described below in detail with reference to the drawings.

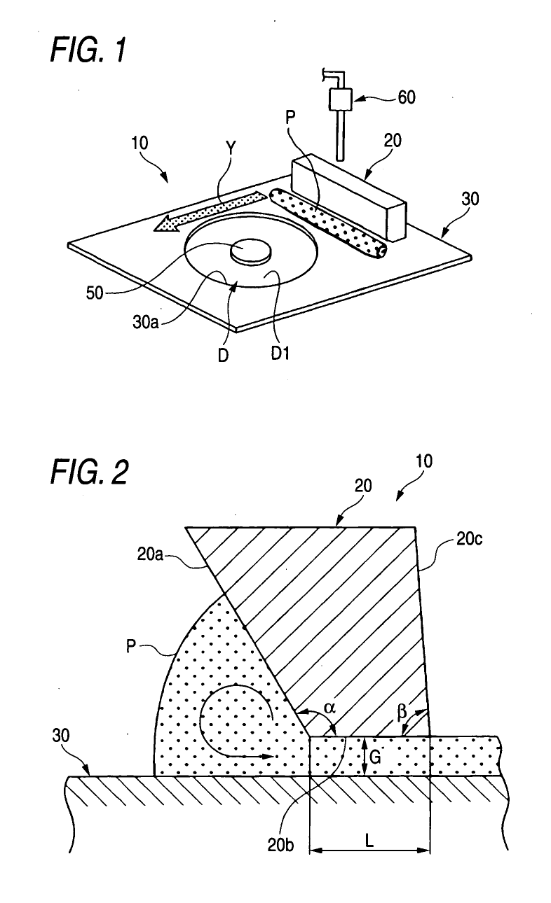

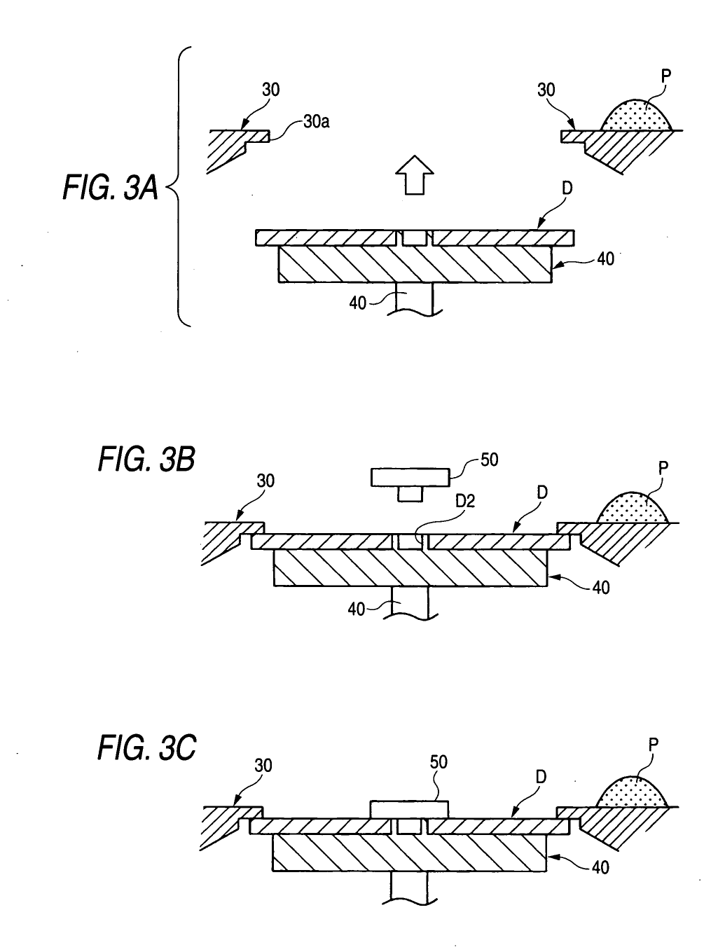

The quantity of a coating liquid supplied by a coating liquid supply unit 60 (FIG. 1) is the largest at an end of a mask. The quantity of the coating liquid decreases as a blade 20 moves. This phenomenon can be examined strictly as follows. At the beginning, the blade 20 moves a large quantity of the coating liquid, so that force to lift up the blade 20 acts on the blade 20 greatly. As a result, the film thickness becomes the largest at the beginning (on the upstream side). It is therefore found that the film thickness decreases as the blade 20 moves.

While paying attention to this phenomenon, the present inventor made an experiment on variation in film thickness allowed in accordance with the relation between the quantity of a coating liquid initially supplied and the quantity of coating liquid consumption used at one stroke. According to this experiments the time of arrival of the blade at a member (serving as a subject of coating) from the start of movement of the blade was not shorter than 0.05 sec, preferably not shorter than 0.1 sec but shorter than 1 sec. Based on this fact, the time was set at 0.5 sec here and the speed of the blade was set at 120 mm per 1.5 sec.

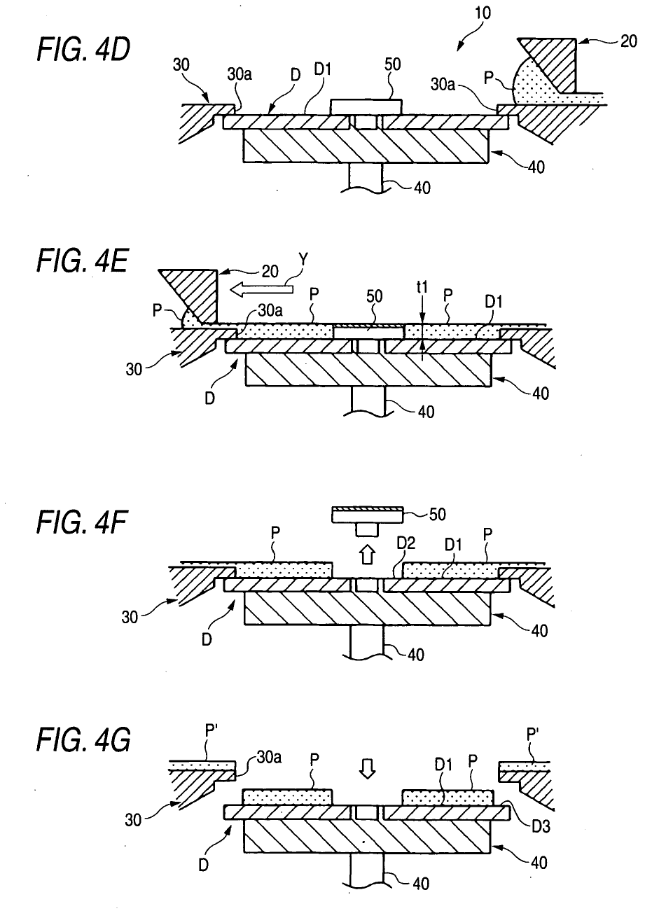

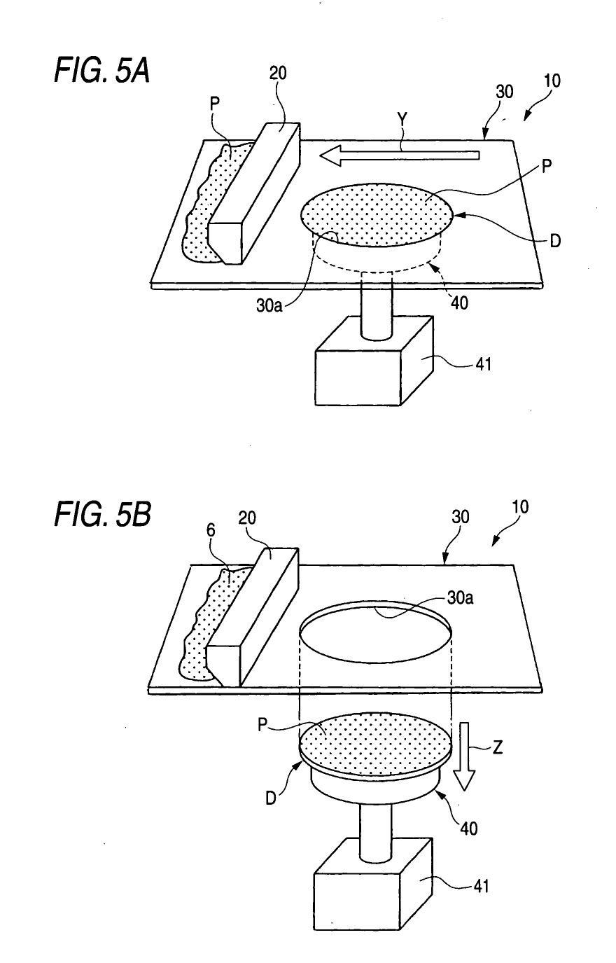

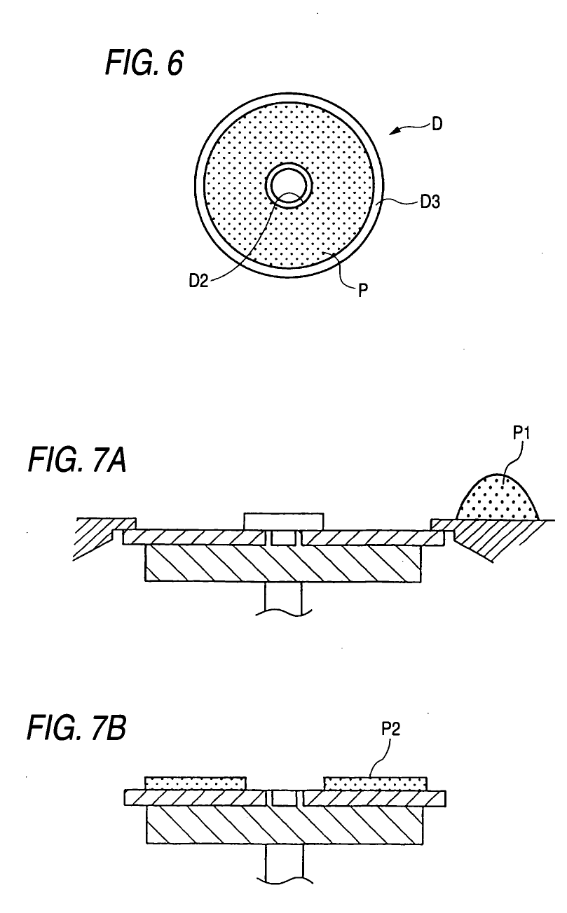

(I) P2 was 2.1 g per sheet when a certain mask 30 was used and a gap t1 (see FIG. 4E) between the blade 20 and the disk D was equal to 300 μm in the condition that P1 was the whole quantity of the coating liquid supplied onto the end of the mask 30 by the coating liquid supply unit 60 (FIG. 1) as shown in FIG. 7A, and P2 was the quantity of coating for the whole film thickness applied on the disk D to form a film thickness determined by the gap t1 as shown in FIG. 7B.

Therefore, while the whole quantity P1 of the coating liquid supplied was changed variously, the situation of coating at that time was observed. Incidentally, in this case, a part of the whole quantity P1 of the supplied coating liquid was used because a coating liquid P′ (see FIG. 4G) was stuck on the mask 30 when printing was performed at the first time. Accordingly, the experiment was conducted in a state in which the coating liquid P′ had been already stuck on the mask 30 (i.e. in a steady state). Accordingly, the whole quantity P1 of the supplied liquid could be completely spent as the quantity P2 of coating for the whole film thickness applied on the disk D.

Table 1 shows results of the experiment in the case where P1 varied within a range of from 2 g to 8 g in the case of (I). According to Table 1, the results were:

(1) dislocation occurred in the coating layer unfavorably when P1=2 g (magnifying power [P1/P2]=0.95);

(2) stripes occurred in end portions unfavorably when P1=4 g (magnifying power=1.90);

(3) coating was excellent when P1=6 g (magnifying power=2.86); and

(4) coating was excellent when P1=8 g (magnifying power=3.81).

TABLE 1

| Liquid | Magnifying | | |
|---|---|---|---|
| quantity | power | State | Judgment |
| 2 g | 0.95 | Dislocation occurred | Bad |
| 4 g | 1.90 | Stripes occurred in | Bad |
| | | end portions | |
| 6 g | 2.86 | Excellent coating | Good |
| 8 g | 3.81 | Excellent coating | Good |

(II) P2 was 1.3 g per sheet when t1 was equal to 200 μm.

Table 2 shows results of the experiment in the case where P1 varied within a range of from 2 g to 10 g in the case of (II).

According to Table 2, the results were:

(1) stripes occurred unfavorably when P1=2 g (magnifying power=1.54);

(2) coating was excellent when P1=6 g (magnifying power=4.62);

(3) swollen coating occurred at the upstream end unfavorably when P1=8 g (magnifying power=6.15); and

(4) thickness unevenness occurred in the whole surface unfavorably when P1=10 g (magnifying power was 7.69).

TABLE 2

| Liquid | Magnifying | | |
|---|---|---|---|
| quantity | power | State | Judgment |
| 2 g | 1.54 | Stripes occurred | Bad |
| 6 g | 4.62 | Excellent coating | Good |
| 8 g | 6.15 | Swollen coating | Bad |
| | | occurred at the | |
| | | upstream end | |
| 10 g | 7.69 | Thickness unevenness | Bad |
| | | occurred in the whole | |
| | | surface | |

As apparent from Tables 1 and 2, it is most preferable that the quantity P1 of the coating liquid remaining in a liquid reservoir on the upstream side of the blade 20 is selected to be in a range of from two times to five times as much as the quantity P2 of the coating liquid applied on one sheet of disk D at one stroke of the blade 20.

If the quantity P1 of the coating liquid was smaller than two times as much as the quantity P2 of the coating liquid, scratches or stripes occurred. On the other hand, if the quantity P1 of the coating liquid was larger than five times as much as the quantity P2 of the coating liquid, swollen coating or thickness unevenness occurred.

Generally, in the case of screen printing, P1 was in a range of from 100 P2 to 1000 P2 because printing was repeated in a range of from 100 times to 1000 times continuously until exhaustion of the coating liquid after P1 was once supplied. In the case of screen printing even in the aforementioned order, the ratio of an aperture of the screen to the whole area of a product was so low that the ratio of the quantity of coating liquid consumption used at one stroke to the whole quantity of the coating liquid was low. For this reason, difference in film thickness between the upstream side and the downstream side or thickness unevenness in the whole surface did not cause a problem in the screen printing.

The present inventor, however, has found that difference in film thickness between the upstream side and the downstream side or thickness unevenness in the whole surface occurs because the blade coating printing uses such a mask that the ratio of the aperture of the mask 30 to the whole area of the disk D is nearly 100%. While paying attention to this problem, the present inventor has finally solved this problem by selecting the quantity P1 of the coating liquid to be in a range of from two times to five times as much as the quantity P2 of the coating liquid applied on a sheet of disk D at a stroke of the blade 30.

In the background art in the field of blade coating printing, it was less possible to take notice of stripes generated in end portions because the quantity P1 of the coating liquid was set to be equal to the quantity P2 of the coating liquid required for one coating cycle so that a minimum quantity necessary for avoiding coating dislocation was used as the quantity P1 of the coating liquid in consideration of production efficiency, etc. It was much less possible to hit on the idea P1=2P2 because of consideration of production efficiency, etc.

Particularly when the subject of coating is a printable surface of a printable optical disk, such printing that the aperture ratio of the mask to the printable surface is nearly 100% is required. When the coating method according to the invention is executed on the printable surface, effectiveness is improved greatly.

As described above, when the coating method according to the invention is carried out in the field which requires such printing that the aperture ratio of the mask to the to-be-coated surface is nearly 100%, a coating layer with a very uniform thickness can be obtained without occurrence of any stripe in end portions of the coating layer on the surface of the disk D, without occurrence of swollen coating at the upstream end of the disk D and without occurrence of thickness unevenness in the whole surface of the disk D.

This application is based on Japanese Patent application JP 2005-35740, filed Feb. 14, 2005, the entire content of which is hereby incorporated by reference, the same as if set forth at length.

What is claimed is:

1. A blade coating method using a blade for coating a surface of a flat substrate with a coating liquid to form a coating layer on a to-be-coated surface of the flat substrate, the method comprising:
attaching a mask onto the flat substrate, the mask having an aperture large enough to apply the coating liquid on the whole surface of the flat substrate except a circumferential edge portion of the flat substrate; and
moving the blade from an upstream side to a downstream side relative to the mask with a predetermined gap formed between the blade and the flat substrate, thereby extruding the coating liquid onto the mask through the gap formed on the downstream side of the blade while moving a quantity of the coating liquid remaining in a liquid reservoir on the upstream side of the blade by the blade to thereby form the coating layer on the surface of the flat substrate,
wherein the quantity of the coating liquid remaining in the liquid reservoir on the upstream side of the blade is set to be in a range of from two times to five times as much as a quantity of the coating liquid to be applied on one sheet of the flat substrate with a stroke of the blade.

2. The blade coating method according to claim 1, wherein the surface of the flat substrate is a printable surface of a printable optical disk.

3. An optical disk comprising at least one layer of a printable surface formed by the blade coating method as claimed in claim 1.

4. A blade coating apparatus comprising:
a subject attachment for attaching a flat substrate as a subject on which a coating liquid is applied;
a blade disposed above the subject attachment so that the blade moves from an upstream side toward a downstream side relative to the subject attachment with a predetermined gap formed between the subject attachment and the blade;
a nozzle for discharging the coating liquid onto the upstream side of the blade; and
a coating liquid quantity controller for controlling the quantity of the coating liquid to be discharged from the nozzle,
wherein the coating liquid quantity controller controls the quantity of the coating liquid to be discharged from the nozzle so that the quantity of the coating liquid to be discharged from the nozzle is set to be in a range of from two times to five times as much as a quantity of the coating liquid to be applied on one sheet of the flat substrate with a stroke of the blade.
